(19) United States
(12) Patent Application Publication
(10) Pub. No.: US 2020/0320576 A1
(43) Pub. Date: Oct. 8, 2020

(54) Targeted Advertising Based On Demographic Features Extracted From Persons

(71) Applicant: Howard Jason Harrison, Bethesda, MD (US)

(72) Inventor: Howard Jason Harrison, Bethesda, MD (US)

(21) Appl. No.: 16/841,008

(22) Filed: Apr. 6, 2020

Related U.S. Application Data
(60) Provisional application No. 62/829,030, filed on Apr. 4, 2019.

(51) Int. Cl. G06Q 30/02; G06K 9/00

(52) U.S. Cl. CPC G06Q 30/0271; G06Q 30/0261; G06K 9/00275; G06K 9/00241; G06K 9/00248; G06K 9/00926

(57) ABSTRACT

Systems and methods to determine demographic attributes of persons in a retail environment are presented. In some examples, media content is selected for presentation to one or more persons based on the determined demographic attributes. In a further example, the media content is interactive, and a response is received from the person indicating recognition of the interactive media content and an identity of the person. In one aspect, a demographic attribute of a person is determined based on biometric attributes of a personal recognition instance and radio frequency information. In another aspect, the demographic attributes of a group of persons passing a particular location are aggregated to determine a demographic profile of a person traffic flow. In this manner, advertisements and incentive offers in the retail facility can be adjusted to meet the desires of the identified demographic profile.

### CROSS REFERENCE TO RELATED APPLICATION

The present application for patent claims priority under 35 U.S.C. § 119 from U.S. provisional patent application Ser. No. 62/829,030, entitled “Biometric And Radio Frequency Communication Based Demography Tool,” filed Apr. 4, 2019, the subject matter of which is incorporated herein by reference in its entirety.

### TECHNICAL FIELD

The described embodiments relate to biometric based identification systems and tools.

### BACKGROUND INFORMATION

Biometric recognition systems are typically employed to identify movement and visual characteristics of live subjects. Media displays are typically employed to deliver advertising content to viewers in a wide variety of settings. Simple, static media displays (e.g., printed or painted graphics and text) remain widely used. Typically, content of a particular static media display is fixed for a lengthy period of time (e.g., weeks or months). In addition to static media displays, dynamic media displays have also been adopted. The content of dynamic media displays can be frequently refreshed. Traditionally, this ability has been utilized to display a series of advertisements so that a passerby may see more than one advertisement before the viewing opportunity ends.

Both static and dynamic media displays are typically located in highly visible areas based on the rationale that highly visible displays reach more potential customers. Moreover, specific advertising content is often displayed in a particular location based on a limited understanding of the demographic profile of viewers at that location. However, in many contexts the understanding of the demographic profile of persons in a retail environment at any given time and the evolution of the demographic profile over time remains very limited. As a consequence, the effectiveness of displayed advertising content is limited. The uncertainty surrounding the effectiveness of display sign advertising generates resistance to capital investment to replace existing signs with more costly signs that provide the ability to display digital media. Improvements in the identification of a demographic profile of persons in a retail environment, its evolution over time, and the selection of media content targeted to the identified demographic profile is desired.

### SUMMARY

Systems and methods to determine demographic attributes of persons in a retail environment are presented. In some examples, media content is selected for presentation to one or more persons based on the determined demographic attributes. In a further example, the media content is interactive, and a response is received from the person indicating recognition of the interactive media content and an identity of the person.

In one aspect, a demographic attribute of a person is determined based on biometric attributes derived from images associated with a personal recognition instance, radio frequency information associated with the personal recognition instance, or both.

In another aspect, the demographic attributes of a group of persons passing a particular location are aggregated to determine a demographic profile of a person traffic flow. In a further aspect, publically available demographic profile data is accessed that indicates the retail likes and dislikes of people that match this demographic profile. In this manner, advertisements and incentive offers in the retail facility can be adjusted to meet the desires of the identified demographic profile.

In another aspect, demographic attributes of persons are derived from repeated personal recognition instances associated with the same person, repeated instances of the same RF information, or both, at the same or different locations. In this manner, demographics can be inferred from repeated visits and movements of a person and a mobile electronics device through the retail facility. A RF/biometric based demography tool compares the biometric attributes associated with one personal recognition instance with another personal recognition instance to find a match and identify repeated instances of the same person. Similarly, the RF/biometric based demography tool compares the RF information associated with one RF communication instance with another RF communication instance to find a match and identify repeated RF communication instances associated with a mobile electronic device likely belonging to the same person.

In yet another aspect, demographic attributes of persons are derived from biometric and RF responses to media content. In this manner, demographic attributes are inferred from the response of persons to media displayed in a retail facility. A RF/biometric based demography tool determines the location and duration of visual attention of each person to a media presentation based on changes in biometric attributes associated with a sequence of images captured during the media presentation, changes in R/F communication, or both. Based on the location and duration of visual attention of the person, a demographic attribute of the person is determined.

In yet another aspect, RF and biometric information is analyzed to determine the number of people in the retail facility at any given time and as a function of time, the rate of ingress and egress of people at a given location (e.g. retail facility entrances) at any given time and as a function of time, the number of repeat visitors present within the retail facility at any given time and as a function of time, etc. In some embodiments, the identity of repeat visitors may be determined from an analysis of RF and biometric information.

The foregoing is a summary and thus contains, by necessity, simplifications, generalizations and omissions of detail. Consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a diagram illustrative of an embodiment of a RF/biometric based demography system in one exemplary operational scenario.

FIG. 2 is a diagram illustrative of an embodiment of a RF/biometric based demography system in yet another exemplary operational scenario.

FIG. 3 is a diagram illustrative of a computer system 110 configured to implement RF/biometric based demography functionality by operation of RF/biometric based demography tool 105.

FIG. 4 is a diagram illustrative of a plurality of personal recognition instances 151-157 stored in memory 150.

FIG. 5 is a diagram illustrative of a RF/biometric based demography system 100 in one embodiment.

FIG. 6 is a diagram illustrative of RF/biometric based demography system 100 in another embodiment.

FIG. 7 is a diagram illustrative of yet another embodiment of RF/biometric based demography system 100.

FIG. 8 is a flowchart illustrative of a method of RF/biometric based demographic profiling 310.

FIG. 9 is a flowchart illustrative of another method of RF/biometric based demographic profiling 320.

FIG. 10 is a flowchart illustrative of yet another method of RF/biometric based demographic profiling 330.

FIG. 11 is a diagram illustrative of a RF/biometric identification engine 400 configured to implement RF/biometric identification functionality as discussed herein.

FIG. 12 is a diagram illustrative of a RF/biometric based demography engine 500 configured to implement RF/biometric based demography functionality as discussed herein.

FIG. 13 is a diagram illustrative of a media content mapping engine 600 configured to implement RF/biometric based media selection functionality as discussed herein.

### DETAILED DESCRIPTION

Reference will now be made in detail to background examples and some embodiments of the invention, examples of which are illustrated in the accompanying drawings.

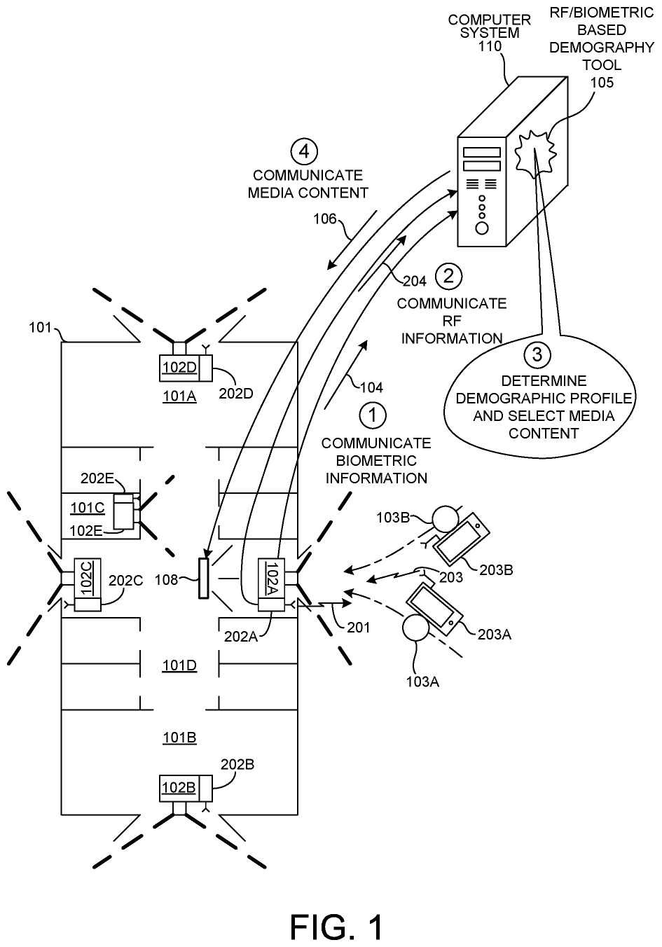

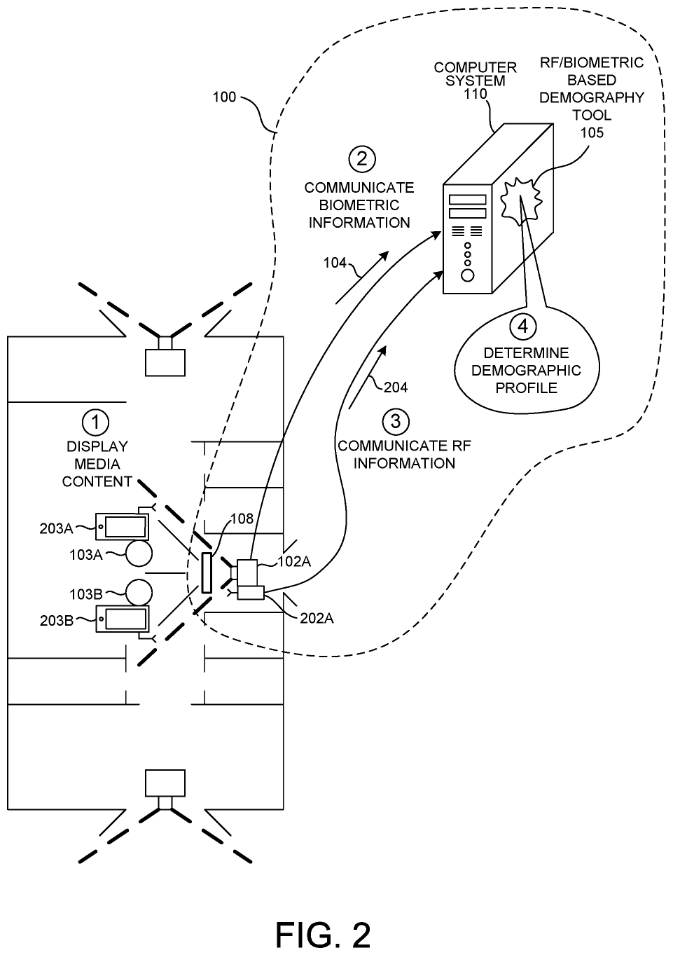

FIG. 1 is a diagram illustrative of an embodiment of a RF/biometric based demography system in one exemplary operational scenario. The RF/biometric based demography system includes one or more biometric recognition units (e.g., biometric recognition units 102A, 102B, 102C, and 102D), one or more RF wireless access point (WAP) units (e.g., WAP units 202A-D), and general purpose computer system 110 operable to implement RF/biometric based demography tool 105. Each biometric recognition unit and each WAP unit is communicatively coupled to general purpose computer system 110. For example, each biometric recognition unit and each WAP unit is communicatively coupled to computer system 110 by a wired or wireless communication link. In some embodiments, computer system 110 is collocated with each biometric recognition unit or WAP unit (e.g., a digital signal processor on board each biometric recognition unit or WAP unit). In some other embodiments, computer system 110 may be distally located from each biometric recognition unit and WAP unit. For example, in some embodiments, computer system 110 is a server or distributed group of servers (e.g., a “cloud” computer system) located at a central facility and computer system 110 is communicatively linked to one or more distally located biometric recognition units, WAP units, or both.

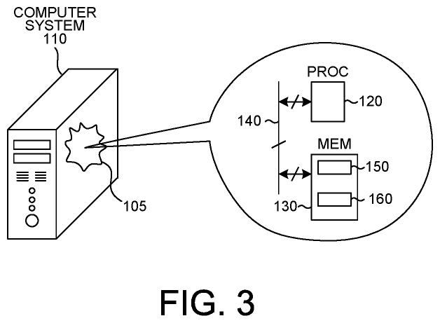

As illustrated in FIG. 3, computer system 110 includes a processor 120 and a memory 130. Processor 120 and memory 130 may communicate over bus 140. Memory 130 includes an amount of memory 150 that stores a number of images captured by a biometric recognition unit and RF information captured by a WAP unit. Memory 130 also includes an amount of memory 160 that stores program code that, when executed by processor 120, causes processor 120 to implement RF/biometric based demography functionality by operation of RF/biometric based demography tool 105.

In the embodiment illustrated in FIG. 1, a number of biometric recognition units 102A-E of a RF/biometric based demography system are placed at various locations of a retail facility 101 (e.g., a mall, shopping center, plaza, etc.). In addition, a number of WAP units 202A-E of a RF/biometric based demography system are placed in close proximity to each biometric recognition unit. Persons walk through retail facility 101 passing within view of various biometric recognition units 102A-E and corresponding WAP units 202A-E. RF/Biometric based demography system 100 captures biometric information 104 associated with persons as they pass each biometric recognition unit 102 and RF information 204 as they pass each WAP unit 202. The RF/Biometric based demography system 100 determines demographic attributes associated with persons based on the biometric information 104, RF information 204, or both.

In addition, in some embodiments, RF/biometric based demography system 100 selects media content 106 based on the demographic attributes, and presents the selected interactive media content 106 to persons as they pass a display unit 108. For example, based on the demographic profile of persons determined by RF/biometric based demography tool 105, advertisements likely to appeal to the persons are presented on display unit 108 within view of the persons.

In addition, in some other embodiments, the RF/biometric based demography system selects media content 106 that is interactive based on the determined demographic attributes, and presents the selected interactive media content 106 to persons as they pass a display unit 108. Persons respond to the displayed interactive media content by communicating a message to computer system 110. The message (e.g., e-mail, text message, text-based web post, etc.) includes the identity of the person (e.g., e-mail address, phone number, web address, etc.) and an indication that the person specifically recognized the interactive media content 106.

In the illustrated embodiment, biometric recognition unit 102A and WAP unit 202A are located in close proximity, but in a different location than display unit 108. However, in other embodiments, they may be collocated (e.g., packaged as one unit). In other embodiments, RF and biometric information is captured outside of retail facility 101 (e.g., sidewalks and parking lots surrounding retail facility 101), but the selected media content is presented within the retail facility 101.

In general, RF/Biometric recognition units are placed in fixed locations in view of passing persons. In some examples, RF/Biometric recognition units are placed within or nearby retail environments. For example, as illustrated in FIG. 1, retail facility 101 includes a mixture of retail spaces. Retail spaces 101A and 101B are large spaces typically reserved for larger stores (i.e., “anchor” stores). In addition, retail facility 101 includes a number of smaller retail spaces (e.g., retail space 101C) and open spaces (e.g., hallway 101D). As illustrated in FIG. 1, by way of non-limiting example, biometric recognition units 102A-D and WAP units 202A-D are located at the entrances and exits of retail facility 101. In addition, biometric recognition unit 102E and WAP unit 202E are located at the entrance of retail space 101C. In some embodiments a number of biometric recognition units and WAP units may be located at a particular location, each configured to capture images of passing persons and RF communications from mobile electronic devices from different perspectives. For example, a biometric recognition unit may be positioned to face persons from an elevated perspective, another positioned to face persons from a ground level perspective, and another positioned to face persons at head level. In other examples, RF/Biometric recognition units are placed in fixed locations in view of persons present within or upon a vehicle (e.g., inside a car, on a bicycle or motorcycle, etc). In these examples, the retail environment accommodates people within or upon vehicles (e.g., drive thru restaurants, banks, laundry, etc.).

In one embodiment, each biometric recognition unit captures image data of passing persons and derives biometric attributes associated with individual persons from the image data. Furthermore, each WAP unit captures RF information from mobile electronic devices from RF communications with mobile electronic devices carried by the persons. The biometric information 104 and RF information 204 is communicated to computer system 110. For example, as illustrated in FIG. 1, biometric recognition unit 102A includes a camera module (not shown) that captures at least one image of passing persons 103A and 103B. In some embodiments, biometric recognition unit 102A includes a timing module that determines the time of image capture and a predetermined code that indicates the location of biometric recognition unit 102A. Each captured image, its time of capture, and location of capture are included in biometric information 104 associated with a distinct personal recognition instance. In addition, in some embodiments, biometric recognition unit 102A performs image analysis on each captured image to identify biometric attributes associated with person 103A. In these embodiments, biometric recognition unit 102A includes an indication of the biometric attributes associated with each personal recognition instance with biometric information 104. In these embodiments, biometric information 104 includes biometric attributes derived from images captured by biometric recognition unit 102A. As depicted in FIG. 1, biometric recognition unit 102A communicates biometric information 104 associated with each personal recognition instance to computer system 110.

In some other embodiments, any of the image analysis functions may be performed by computer system 110. In one example, biometric information 104 communicated from biometric recognition unit 102A to computer system 110 includes captured image data and the time of capture associated with each personal recognition instance and additional image processing tasks to determine biometric attributes are performed by computer system 110. In this example (illustrated in FIG. 6), a biometric recognition unit 102 is simply an image capture unit and image information 107 without biometric attributes, is communicated to computer system 110. In another example, the burden of image analysis is shared between biometric recognition unit 102 and computer system 110.

Each WAP unit (e.g., router, Wi-Fi hotspot, etc.) is placed in a fixed location in view of passing persons, typically in close proximity to a corresponding biometric unit, or alternatively, integrated together with a biometric unit. For example, WAP unit 202A broadcasts messages 201 inviting mobile electronic devices (e.g., mobile phones, tablets, etc.), such as mobile phone 203A carried by person 103A to communicate with WAP unit 202A. In response, the mobile electronic devices respond with a message (e.g., message 203) indicating its MAC (media access control) address. In some embodiments, a mobile electronic device broadcasts its MAC address, periodically, without prompting. For example, mobile phones frequently broadcast a request to connect (e.g., once per minute). As depicted in FIG. 1, mobile device 203A transmits signals 203 indicating its MAC address.

In addition, WAP unit 202A receives signals from mobile electronic devices (e.g., signals 203) and determines an indication of the signal strength (e.g., Received Signal Strength Indicator (RSSI)) associated with each received signal. The signal strength is indicative of the distance between WAP 202A and the mobile electronic device. In this manner, signals received from mobile electronic devices by WAP 202A at any given time can be grouped together by their proximity to WAP 202A, and thus the likelihood that one or more mobile electronic devices are carried by a particular passing person.

In some embodiments, the distance between a WAP unit (e.g., WAP unit 202A) and a mobile electronic device is estimated by WAP unit 202A or computer system 110 based on analysis of RSSI. In some of these embodiments, image capture by a nearby biometric recognition unit (e.g., biometric recognition unit 102A) is triggered when the estimated distance is below a predetermined threshold value. In this manner, the WAP unit acts a proximity sensor to optimize image capture by a corresponding biometric recognition unit. In other embodiments, the presentation of an advertisement (e.g., on display 108) is initiated based on the estimated distance. In this manner, the WAP unit acts as a proximity sensor to optimize presentation of advertisements to a person by ensuring that the advertisement is presented in full view of the person.

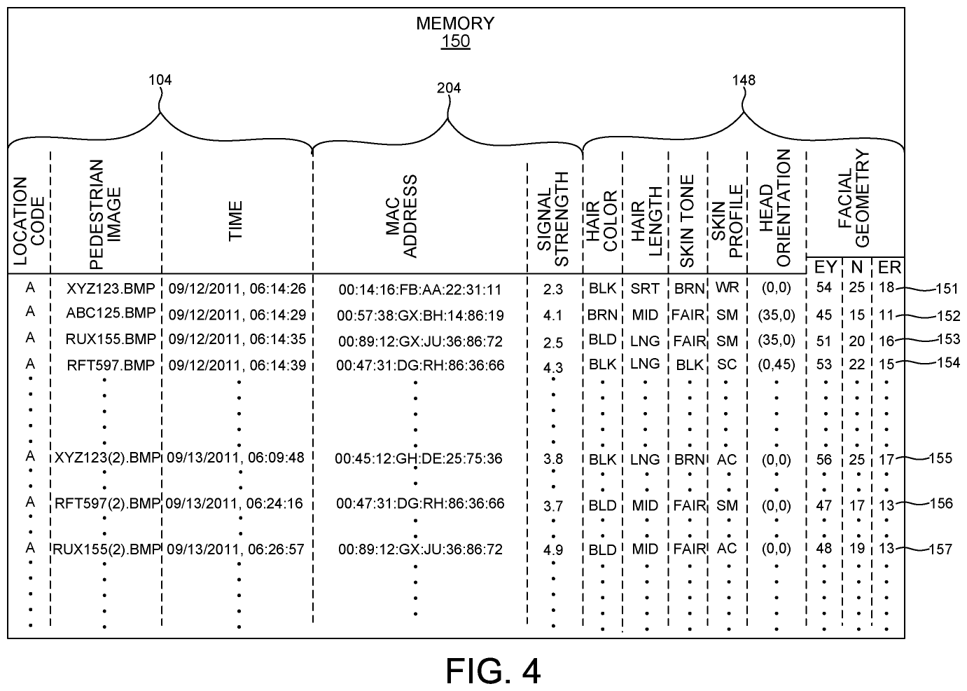

Biometric information 104 and RF information 204 received by computer system 110 is stored in memory 150. FIG. 4 is illustrative of a plurality of personal recognition instances 151-157 stored in memory 150. Each personal recognition instance includes biometric information 104 received from biometric recognition unit 102 and RF information received from WAP unit 202. In the illustrated example, biometric information 104 includes a location code, image information, and the time of image capture. RF information 204 includes MAC addresses received during the time between the last personal recognition instance and the current personal recognition instance and the signal strength associated with each received MAC address.

In some embodiments, the media content is selected and presented to a person on a display (e.g., on display 108) based on a recognized MAC address nearby the display unit. For example, the captured MAC address indicates that the mobile electronic device is an Apple® iPhone SE®, and analysis of the RF signal strength indicates that the mobile electronic device is within 10 feet of display 108. In response, content mapping module 172 selects display content 146 including an advertisement for another Apple® product or service for presentation on display 108.

In some embodiments, biometric information 104 includes captured image data including still images, video, or both. In addition, computer system 110 extracts at least one demographic attribute of the person associated with the personal recognition instance from the captured image data using a trained artificial intelligence (AI) based model. The AI based model is a machine learning (ML) model that has been trained on image data having known demographic attributes. Exemplary ML models include a neural network model, a support vector machines model, a random forest model, a decision tree model, Bayesian model, etc. By way of non-limiting example, demographic attributes extracted from one or more images of a passing person include gender, race, age, size, etc.

In some other embodiments, other demographic attributes of the person associated with the personal recognition instance are extracted from the captured image data. In some embodiments, the clothing type (e.g., pants, shorts, skirt, t-shirt, buttoned shirt, sweater, etc., the brands associated with each clothing type, etc., are demographic attributes identified from the captured image data using a trained AI model. In response, advertisements selected base on one or more of the identified demographic attributes are communicated to the person. In some embodiments, the advertisements are communicated to the person via visual display fixed in the environment and visible to the person. In some other embodiments, advertisements are communicated to the person via a mobile electronic device associated with the person.

In one aspect, a demographic attribute of a person is determined based on a match between biometric attributes of a personal recognition instance associated with the person and a biometric template.

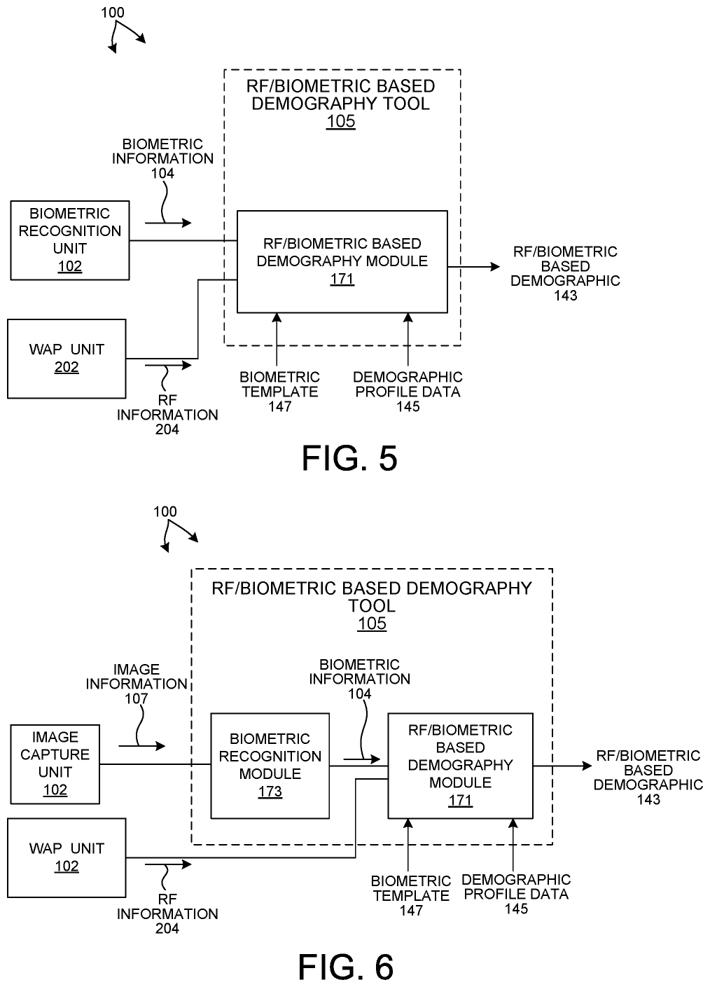

FIG. 5 illustrates RF/biometric based demography system 100 in one embodiment. As illustrated, RF/biometric based demography tool 105 executed, for example, on computer system 110 receives biometric information 104 generated by biometric recognition unit 102 and RF information 204 received from WAP unit 202. In addition, computing system 110 determines one or more biometric attributes 148 from one or more images associated with the personal recognition instance. By way of non-limiting example, biometric attributes include an indication of the hair color, hair length, skin tone, skin profile, head orientation, and facial dimensions of the person. RF/Biometric based demography module 171 of RF/biometric based demography tool 105 compares at least one biometric attribute 148 with a biometric template 147 to find a match. A demographic attribute of the person associated with the personal recognition instance is identified if a match is found. For example, as illustrated in FIG. 5, each personal recognition instance includes facial geometry dimensions for eye spacing (“EY”), nose width (“N”), and ear spacing (“ER”). In one example, a biometric template 147 associated with a small child may include dimensional ranges of these facial features that are consistent with a small child. An exemplary biometric template associated with a small child may include eye spacing between 41 millimeters and 47 millimeters, a nose width between 13 millimeters and 17 millimeters, and ear spacing between 10 centimeters and 14 centimeters. By comparing biometric attributes of personal recognition instance 152 with this biometric template, a match is found because each of these dimensions is within the range specified by biometric template 147. In this manner, a demographic attribute associated with personal recognition instance 152 is identified as a small child.

In addition, if a mobile electronic device associated with a person is identified as an Apple® iPhone SE®, for example, it may be determined based on publically accessible demographic studies that 70% of the owners of this watch are children between the ages of 10 and 18 years old, 15% are retired females between the ages of 55 and 70 years old, and the rest belong in other categories.

In this manner, at least one demographic attribute associated with each person associated with a personal recognition instance may be identified by corroborating biometric and RF attributes. Exemplary demographic attributes include age, gender, sex, and race of passing persons.

In another aspect, the demographic attributes of a group of persons passing a particular location may be aggregated to determine a demographic profile of the person traffic flow. In one embodiment, RF/biometric based demography module may determine the demographic profile at a given location and time of day is 30% of passing persons are children, 20% are mid-aged female, 5% are mid-aged male, and 40% are elderly males and females based on aggregation of demographic attributes. In addition, RF/biometric based demography module 171 may access publically available demographic profile data 145 that indicates the retail likes and dislikes of people that match this demographic profile. In this manner, advertisements and incentive offers in the retail facility can be adjusted to meet the desires of the identified demographic profile.

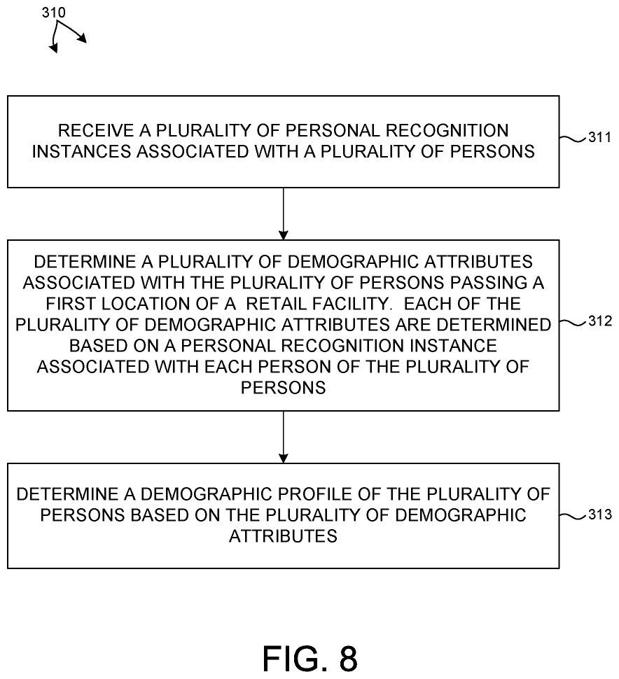

FIG. 5 is illustrative of RF/biometric based demography tool 105 operable in accordance with the method of biometric based demographic profiling 310 illustrated in FIG. 8. This illustration and corresponding explanation are provided by way of example as many other embodiments and operational examples may be contemplated. In the depicted embodiment, RF/biometric based demography tool 105 includes RF/biometric based demography module 171. In the depicted embodiment, RF/biometric based demography tool 105 receives biometric information 104 from biometric recognition unit 102 and RF information 204 from WAP unit 202. In block 311, of method 310, RF/biometric based demography module 171 receives a plurality of personal recognition instances associated with a plurality of persons. In one example of block 312, RF/biometric based demography module 171 determines a plurality of demographic attributes associated with a plurality of persons passing a first location of a retail facility. Each of the plurality of demographic attributes is determined based on a personal recognition instance of each person. In one example of block 313, RF/biometric based demography module 171 determines a demographic profile of the plurality of persons based on the plurality of demographic attributes. The resulting RF/biometric based demographic 143 is communicated from RF/biometric based demography module 171 for further use by a user of RF/biometric based demography tool 105.

FIG. 6 is illustrative of RF/biometric based demography tool 105 operable in a manner analogous to that of FIG. 5. In the embodiment illustrated in FIG. 6, RF/biometric based demography tool 105 includes biometric recognition module 173 operable to receive image information 107 from an image capture unit 102 and determine biometric information 104 from image information 107. Thus, in this embodiment, RF/biometric based demography tool 105 derives the biometric information associated with each personal recognition instance.

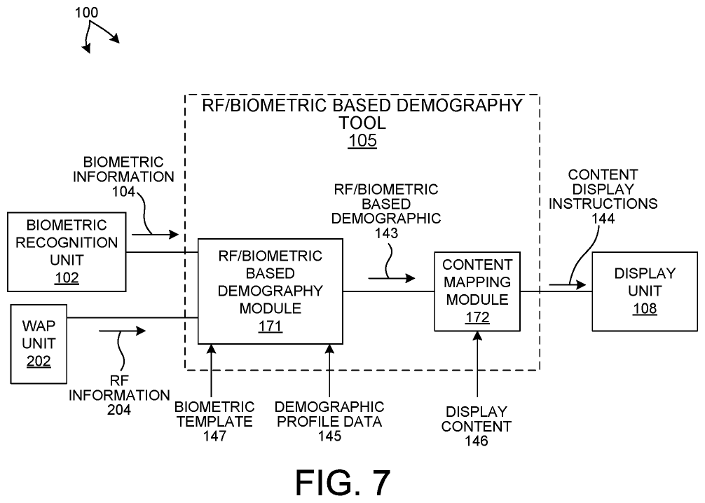

FIG. 7 is illustrative of another embodiment of RF/biometric based demography system 100. In the depicted embodiment, RF/biometric based demography tool 105 includes a RF/biometric based demography module 171 and media content mapping module 172. In the depicted embodiment, RF/biometric based demography tool 105 receives biometric information 104 from biometric recognition unit 102 and RF information 204, and determines RF/biometric based demographics 143 as discussed herein. For example, the RF/biometric based demographics 143 indicates a high percentage of persons who are working professionals between ages 35 and 50 years old. Based on the RF/biometric based demographics 143, media content mapping module 172 selects an amount of media content for presentation. Media content mapping module 172 may access display content 146 including a number of different advertisements each targeted differing demographic groups. Media content mapping module 172 maps the RF/biometric based demographics 143 with advertisements that target those demographics. For example, an advertisement for luxury wristwatches is targeted to male and female working professionals between ages 35 and 50 years old. In one example, media content mapping module 172 assigns a high score to the match between the advertisement for luxury wristwatches with the demographics of the passing persons (e.g., 85% match). In contrast, an advertisement for low-priced alcoholic beverages does not target male and female working professionals between ages 35 and 50 years old. As a result, media content mapping module 172 assigns a low score to the match between the advertisement for low-priced alcoholic beverages and the demographics of the passing persons. Based on the assigned scores, content mapping module 172 selects high scoring display content for presentation to the passing persons. Content mapping module 172 generates content display instructions 144 that cause display unit 108 to present the selected interactive media content. For example, content mapping module generates content display instructions 144 that cause display unit 108 to display the two highest ranked advertisements in rank order for five seconds each.

In some embodiments, the selected media content may be interactive. Interactive media content includes an invitation to respond to the interactive media content electronically. In some embodiments, interactive media content includes a unique identifier that allows a viewer (e.g., person 103A) to authenticate his or her recognition of the specific interactive media content. For example, an interactive advertisement for a luxury wristwatch may include a promotional code. If the viewer sends an electronic message to computer system 110 that includes the code, the viewer receives a discount on a future purchase of the luxury wristwatch.

In one example, a response to the interactive media content is received by computer system 110 from person 103A. The response includes an indication that the person specifically recognized the interactive media content (e.g., a code embedded in the interactive media content). In addition, the response includes an indication of the identity of the person (e.g., name, e-mail address, etc.). In this manner, additional interaction between the advertiser and the person 103A may occur.

In another aspect, demographic attributes of persons may be derived from repeated RF/biometric instances associated with the same person and mobile electronic device at the same or different locations. In this manner, demographics can be inferred from repeated visits and movements of a person through the retail facility. In one example, the same RF/biometric attributes may be repeatedly recognized by a biometric recognition unit 102 and WAP unit 202 each day at a similar time. Based on this pattern of biometric instances, it can be inferred that the person is a frequent shopper. In another example, the same RF/biometric attributes may be repeatedly recognized at the entrances of the two high end clothiers located in the retail facility. Based on this pattern of personal recognition instances, it can be inferred that the person likes expensive goods. In another example, the same RF/biometric attributes may be repeatedly recognized in the hallways of the retail facility, but not in the stores. Based on this pattern of personal recognition instances, it can be inferred that the person likes to browse, but is not a frequent buyer.

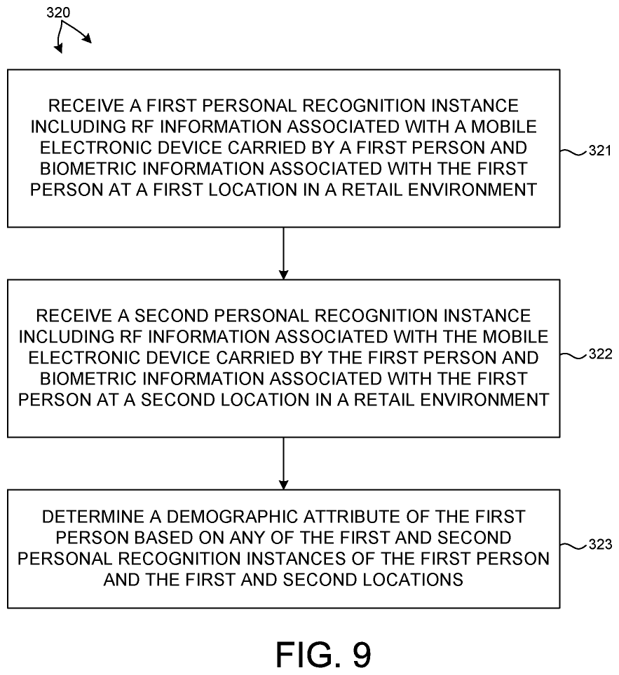

FIG. 5 is illustrative of biometric based demography tool 105 operable in accordance with the method of biometric based demographic profiling 320 illustrated in FIG. 9. This illustration and corresponding explanation are provided by way of example as many other embodiments and operational examples may be contemplated. In the depicted embodiment, RF/biometric based demography tool 105 includes RF/biometric based demography module 171. In one example of block 321 of method 320, RF/biometric based demography tool 105 receives a first personal recognition instance including biometric information associated with a first person at a first location in a retail environment from a biometric recognition unit 102 and a first instance of RF information 204 from WAP unit 202 at the first location. In one example of block 322 of method 320, RF/biometric based demography tool 105 receives a second personal recognition instance including biometric information associated with the first person at a second location in the retail environment and a second instance of RF information 204 associated with the same mobile electronic device at the second location. In one example of block 323 of method 320, RF/biometric based demography module 171 determines a demographic attribute of the first person based on any of the first and second personal recognition instances of the first person and the first and second locations. The resulting RF/biometric based demographic 143 is communicated from RF/biometric based demography module 171 for further use by a user of RF/biometric based demography tool 105.

In yet another aspect, demographic attributes of persons may be derived from biometric responses to media content. In this manner, demographics can be inferred from the response of persons to media displayed in a retail facility. For example, as illustrated in FIGS. 3 and 6, biometric recognition module 102A repeatedly captures time sequenced image data of persons 103A and 103B while they are within view of media content being displayed on display 108 and WAP unit 202A repeatedly captures time sequenced RF information from mobile electronic devices in proximity to persons while they are within view of media content being displayed on display 108. For each image capture, biometric recognition module 102A generates biometric attributes associated with persons 103A and 103B and communicates the biometric attributes to computer system 110. RF/Biometric based demography module 171 of RF/biometric based demography tool 105 determines the location and duration of visual attention of each person and the corresponding duration of each mobile electronic device during the time sequence based on the biometric attributes associated with the personal recognition instances of the time sequence. Based on the location and duration of visual attention of the person, RF/biometric based demography module 171 determines a demographic attribute of the person.

For example, as illustrated in FIG. 4, each personal recognition instance includes a measurement of head orientation. In the illustrated example, head orientation is expressed as a pair of angles to express the degree of vertical and horizontal tilt of the head relative to the display. For example, the angle pair “(0,0)” indicates that the head is exactly facing the display. The angle pair “(35,0)” indicates the person's head is tilted horizontally from the display by thirty five degrees, but is vertically in line with the display. This characterization of relative orientation of the head is exemplary. Many other coordinate schemes may be contemplated.

Based on the head orientation of persons 103A and 103B during the time sequence of successive image captures, RF/biometric based demography tool 105 determines the location and duration of visual attention of each person during the time sequence. For example, if the head orientation for each personal recognition instance of person 103A during the time sequence is “(0,0),” biometric based demography tool 105 determines that person 103A was watching the display 108 for the entire time sequence. Similarly, if the head orientation of person 103B was initially “(0,0)” and then changed to “(35,0)” during the time sequence, RF/biometric based demography tool 105 determines that person 103A was initially watching the display 108, but then turned away from the display.

In some embodiments, the location and duration of visual attention of each person is extracted from captured video using a trained artificial intelligence (AI) based model. The AI based model is a machine learning (ML) model that has been trained on video streams having known values of location and duration of visual attention.

Based on the media content displayed and the location and duration of visual attention of each person during the time sequence, RF/biometric based demography module 171 determines a demographic attribute of the person. For example, if the media content includes a trailer for an upcoming horror movie, RF/biometric based demography module 171 determines the demographic attribute that person 103B is not interested in horror movies based on person 103B turning away from the display.

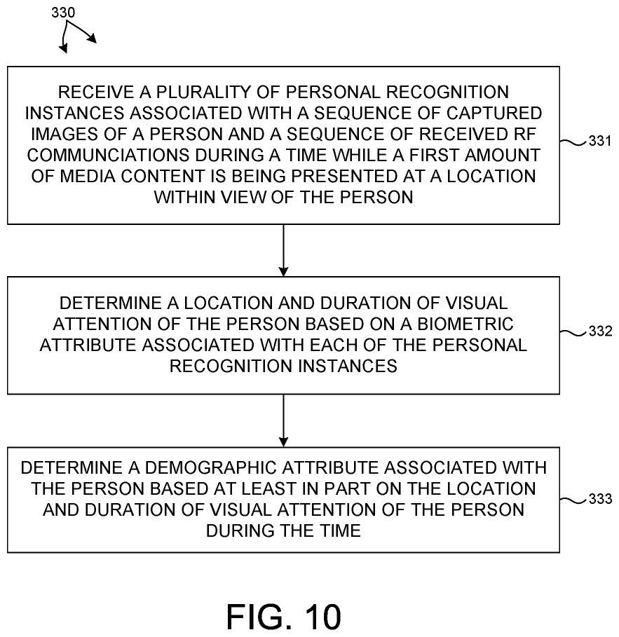

FIG. 5 is illustrative of RF/biometric based demography tool 105 operable in accordance with the method of biometric based demographic profiling 330 illustrated in FIG. 10. This illustration and corresponding explanation are provided by way of example as many other embodiments and operational examples may be contemplated. In the depicted embodiment, RF/biometric based demography tool 105 includes biometric based demography module 171. In one example of block 331 of method 330, RF/biometric based demography tool 105 receives a plurality of personal recognition instances associated with a sequence of images of a person and RF information captured during a time while a first amount of media content is being presented at a location within view of the person. In one example of block 332 of method 330, RF/biometric based demography tool 105 determines a location and duration of visual attention of the person based on a biometric attribute associated with each of the personal recognition instances. In one example of block 333 of method 330, RF/biometric based demography tool 105 determines a demographic attribute associated with the person based at least in part on the location and duration of visual attention of the person during the time. The resulting RF/biometric based demographic 143 is communicated from RF/biometric based demography module 171 for further use by a user of RF/biometric based demography tool 105.

As discussed herein, each biometric recognition unit 102 captures image data of passing persons and communicates biometric information 104 to computer system 110. Similarly, each WAP unit captures RF information associated with mobile electronic devices carried by individual persons and communicates the RF information to computer system 110. In one aspect, biometric information 104 and RF information 204 may be analyzed to determine the number of people in the retail facility at any given time and as a function of time, the rate of ingress and egress of people at a given location (e.g. retail facility entrances) at any given time and as a function of time, the number of repeat visitors present within the retail facility at any given time and as a function of time, etc. In some embodiments, the identity of repeat visitors may be determined from an analysis of biometric information 104 and RF information 204.

In another further aspect, the identity of a person or an electronic device associated with the person is verified at a point of purchase of the advertised product. For example, an RF/biometric based demography system 100 may also be located at a point of purchase (e.g., a point of sale terminal, etc.) In some embodiments, the RF/biometric based demography system 100 identifies the biometric features of a purchaser, MAC address of electronic device associated with a purchaser, or both, at a point of purchase. Furthermore, the identified biometric features, MAC address, or both, are linked to advertisements displayed in view of a person having the same biometric features, a person associated with the same electronic device, or both. In this manner, a link is established between the advertisement and a subsequent transaction associated with the advertisement.

As discussed above, methods 310, 320, and 330 may be executed by RF/biometric based demography tool 105 running within computer system 110. An operator may interact with RF/biometric based demography tool 105 via a locally delivered user interface (e.g., GUI displayed by terminal equipment directly connected to computer system 110). In other embodiments, an operator may interact with RF/biometric based demography tool 105 via a web interface communicated over the internet.

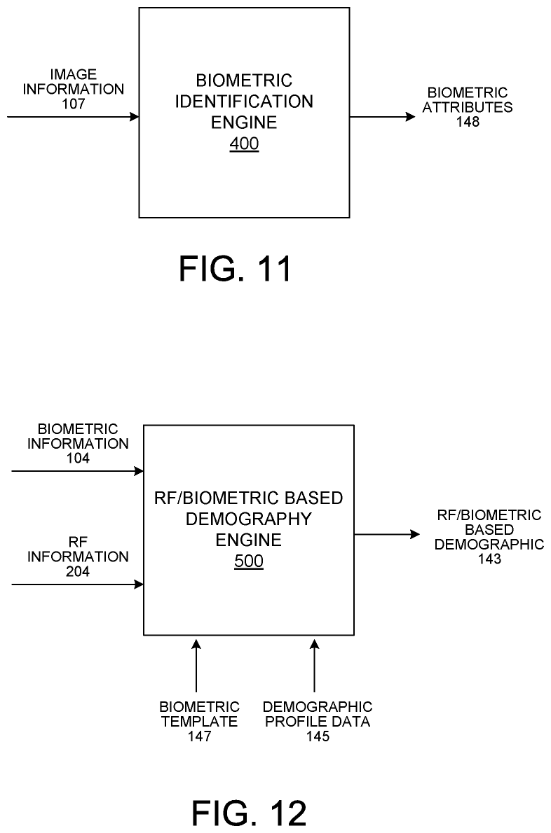

Although, methods 310, 320, and 330 may be executed by RF/biometric based demography tool 105 running within computer system 110, it may also be executed entirely or in part by dedicated hardware. FIG. 11 illustrates a biometric identification engine 400 configured to implement biometric identification functionality as discussed herein. In one example, biometric identification engine 400 receives image information 107 as input. Biometric identification engine 400 implements biometric identification functionality as discussed herein and generates biometric attributes, such as biometric attributes 148.

Although, methods 310, 320, and 330 may be executed by RF/biometric based demography tool 105 running within computer system 110, it may also be executed entirely or in part by dedicated hardware. FIG. 12 illustrates a RF/biometric based demography engine 500 configured to implement RF/biometric based demography functionality as discussed herein. In one example, RF/biometric based demography engine 500 receives biometric information 104, RF information 204, biometric template data 147, and demographic profile data 145 as input. RF/Biometric based demography engine 500 implements RF/biometric based demography functionality as discussed herein and generates RF/biometric based demographics 143.

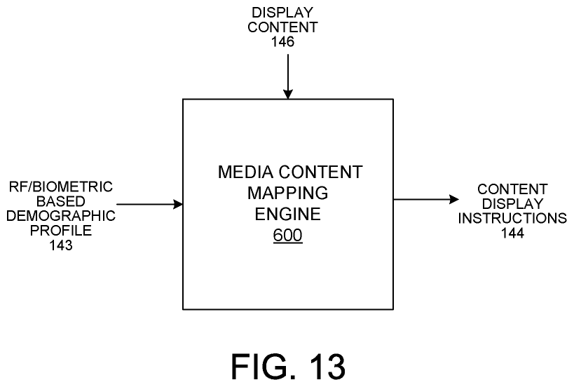

Although, methods 310, 320, and 330, may be executed by RF/biometric based demography tool 105 running within computer system 110, it may also be executed in part by dedicated hardware (e.g., application specific integrated circuit, field programmable gate array, etc.). FIG. 13 illustrates a media content mapping engine 600 configured to implement RF/biometric based media selection functionality as discussed herein. In one example, media content mapping engine 600 receives RF/biometric based demographics 143 and display content 146 as input. Media content mapping engine 600 implements RF/biometric based media selection functionality as discussed herein and generates content display instructions 144 useable to command a display unit 108 to display particular media content.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. For example, selected interactive media may be presented by a display unit 108, however, in other examples, selected interactive media may be presented by targeted e-mails or conventional mailings based on the identified demographic profile. In another example, in addition to demographic data, general person traffic statistics can be accumulated by biometric based demography system 100. For example, a cumulative count of passing persons can be generated. In another example, a cumulative count of each identified demographic group of persons can be generated. For example, the number of women, men, elderly, and children may be tracked over time. This information may be useful for planning purposes for future development of the retail facility. Accordingly, various modifications, adaptations, and combinations of various features of the described embodiments can be practiced without departing from the scope of the invention as set forth in the claims.

1. A method comprising:
receiving a first personal recognition instance including RF information associated with a mobile electronic device carried by a first person and biometric information associated with the first person at a first location in a retail environment;
receiving a second personal recognition instance including RF information associated with the mobile electronic device carried by the first person and biometric information associated with the first person at a second location in a retail environment; and
determining a demographic attribute of the first person based on any of the first and second personal recognition instances of the first person and the first and second locations.

2. The method of claim 1, further comprising:
selecting an amount of media content for presentation to the person based at least in part on the determined demographic attribute; and
presenting the amount of media content to the person.

3. The method of claim 2, wherein the amount of media content is interactive media content, and further comprising:
receiving a response to the interactive media content indicating a recognition of the interactive media content and an identity of the person.

4. The method of claim 1, wherein the first location is the entrance of a first retail store and the second location is the entrance of a second retail store.

5. The method of claim 1, further comprising:
receiving a third personal recognition instance including biometric information associated with a second person at the first location in the retail environment;
receiving a fourth personal recognition instance including biometric information associated with the second person at the second location in the retail environment; and
determining a demographic attribute of the second person based on any of the first and second personal recognition instances of the second person and the first and second locations.

6. The method of claim 5, further comprising:
determining a demographic profile based on the demographic attributes of the first person and the second person and the first and second locations.

7. The method of claim 1, wherein the determining of the demographic attribute associated with the first person involves associating publically available demographic information with the biometric information associated with the first person.

8. A method comprising:
receiving a plurality of personal recognition instances associated with a plurality of persons;
determining a plurality of demographic attributes associated with the plurality of persons passing a first location of a retail facility, each of the plurality of demographic attributes are determined based on a personal recognition instance of the plurality of personal recognition instances associated with each person of the plurality of persons; and
determining a demographic profile of the plurality of persons based on the plurality of demographic attributes.

9. The method of claim 8, further comprising:
selecting an amount of media content for presentation to the plurality of persons based at least in part on the determined demographic profile; and
presenting the amount of media content to the plurality of persons.

10. The method of claim 9, wherein the amount of media content is interactive media content, and further comprising:
receiving a response to the interactive media content indicating a recognition of the interactive media content and an identity of at least one of the plurality of persons.

11. The method of claim 8, wherein the determining of the plurality of demographic attributes associated with the plurality of persons involves associating publically available demographic information with the RF information and biometric attributes associated with each of the plurality of persons.

12. The method of claim 11, wherein a biometric attribute includes any of a plurality of facial dimensions, a skin tone, a hair color, a head size, and a head orientation.

13. The method of claim 11, wherein the demographic attribute includes any of a gender of the person, an age of the person, and a race of the person.

14. The method of claim 8, wherein the location is the entrance of the retail facility.

15. A method comprising:
receiving a plurality of personal recognition instances associated with a sequence of captured images of a person and a sequence of received RF communications during a time while a first amount of media content is being presented at a location within view of the person;
determining a location and duration of visual attention of the person based on a biometric attribute associated with each of the personal recognition instances; and
determining a demographic attribute associated with the person based at least in part on the location and duration of visual attention of the person during the time.

16. The method of claim 15, further comprising:
selecting a second amount of media content for presentation at the location based at least in part on the determined demographic attribute.

17. The method of claim 16, wherein the second amount of media content is interactive media content, and further comprising:
receiving a response to the interactive media content indicating a recognition of the interactive media content and an identity of the person.

18. The method of claim 17, wherein the interactive media content includes an invitation to respond to the interactive media content electronically.

19. The method of claim 18, wherein the invitation to respond includes a code that identifies the invitation, and wherein the response indicating the recognition of the interactive media content includes the code.

20. The method of claim 15, wherein the determining of the demographic attribute of the person involves associating publically available demographic information identified with the first amount of media content.
